(19) United States
(12) Patent Application Publication
(10) Pub. No.: US 2010/0251466 A1
(43) Pub. Date: Oct. 7, 2010

(54) SELECTIVELY PERMEABLE CHEMICAL PROTECTIVE FILMS AND COMPOSITE FABRICS

(75) Inventors: John D. Langley, Guntersville, AL (US); Jason R. Cole, Arab, AL (US); Adam J. Terrell, Horton, AL (US)

Correspondence Address: STITES & HARBISON PLLC, 401 COMMERCE STREET, SUITE 800, NASHVILLE, TN, 37219, US

(73) Assignee: Kappler, Inc.

(21) Appl. No.: 12/755,959

(22) Filed: Apr. 7, 2010

Related U.S. Application Data
(60) Provisional application No. 61/212,116, filed on Apr. 7, 2009.

(51) Int. Cl. A62B 17/00; B32B 3/26; B32B 5/24; B32B 1/02; B32B 7/14; B32B 5/32

(52) U.S. Cl. 2/458; 428/304.4; 442/181; 442/304; 442/327; 428/34.1; 428/196; 428/315.9; 442/401; 428/315.5; 428/36.1

(57) ABSTRACT

A breathable, semi-permeable, laminate that includes at least one a semi-permeable layer having top and bottom surfaces; at least one microporous liquid impermeable layer bonded to at least one surface of the semi-permeable layer; and at least one textile layer.

### PRIORITY INFORMATION

This application claims benefit to U.S. patent application Ser. No. 61/212,116, filed Apr. 7, 2009, the contents of which are incorporated herein by reference in their entirety.

### FIELD OF THE INVENTION

The present invention relates to chemical protective clothing and the fabrics used therein. More specifically the present invention relates to chemical protective composite fabrics that also allow body moisture to escape providing comfort to the wearer.

### BACKGROUND OF THE INVENTION

The use of coated textile composites or laminates of textiles and liquid protective barrier membrane layers to create liquid-proof protective apparel is well known in the industry. A common example is water-proof breathable apparel. This example may be sold by W. L. Gore and Associated, Inc. under the trade name GORE-TEX, which contains a water-proof breathable film laminated, or bonded, to one or more textile layers. These laminates are fabricated into apparel and sold as GORE-TEX garments and the like.

Over the last few decades the choices of chemical protective clothing and ensembles available to hazardous materials clean up responders and plant workers have expanded significantly. The popular breathability characteristics of materials such as GORE-TEX were investigated to determine if such characteristics could be incorporated into chemical protective fabrics.

Additionally, as awareness of the hazards associated with dangerous and toxic chemicals in the liquid and or vapor forms increased, the chemical protective fabrics began to transition from rubber or PVC based fabrics to the more chemical permeation resistant film based fabrics. In 1977 the ASTM formed the F23 committee on protective clothing. This committee has issued numerous test standards that have impacted the development of chemical protective clothing. One such standard was ASTM F739 which standardized how chemical permeation through protective fabrics is measured. This standard, which measures chemical migration through the fabric on a molecular level, highlighted the differences between traditional rubber products and newer barrier films. Another standard, ASTM F1001 established a chemical test battery consisting of 15 liquid chemicals and 6 gases representing a broad base of chemical families. If one chooses to document to this standard, all chemicals must be tested and reported. This again highlighted the advantage of high barrier films over the then traditional elastomeric fabrics.

One of the earliest film based fabrics to be developed was SARANEX 23 (DOW) laminated to TYVEK (DUPONT). SARANEX barrier films are multilayer polymer (plastic) films consisting of a SARAN resin (polyvinylidene chloride, PVDC) core layer and different types of thermoplastic polymer resins for the outer layers. The SARAN resin prevents air, water vapor, and aromas from getting in or out. The SARAN resin layer is sandwiched between layers of modified thermoplastic film. This thin material offered considerable chemical protection compared to elastomeric products and solved the difficult problem of garment decontamination since this product was designed to be disposed of after use.

U.S. Pat. No. 4,833,010 issued to Kappler, Inc. in 1989 describes a material that is heat sealable and exhibited greater than 8 hours permeation resistance to all of the ASTM F1001 chemicals. This material was used to fabricate gas tight suits offering the highest level of protection while still being designed for disposal after exposure to chemicals.

While the film based products offer excellent chemical resistance, they effectively block the wearer's body's ability to cool itself by evaporative cooling. This is due to the fact that the films have very low moisture vapor transmission rates (MVTR). The absence of moisture vapor transfer ability causes sweat to form on the skin and the body core temperature can rise to dangerous levels, especially when strenuous work is being performed. In a totally encapsulating gas tight suit, the core temperature is traditionally controlled by work rest cycles. In addition, the length of time the suit can be used in one wearing is typically limited by the SCBA (self contained breathing apparatus). This type of suit is commonly used for the initial response to a hazardous incident in order to identify the hazardous chemicals involved.

Extended duration work cycles requiring chemical protective clothing are common in many applications including chemical plant workers, clean up after hazardous chemical spills, working with or around chemical warfare agents, and terrorism incidents that may also involve law enforcement agencies. It is these types of uses that comfort and the reduction of heat stress would be most beneficial.

The first national standard to mandate a degree of comfort in chemical protective clothing is NFPA 1994, “Protective Ensembles for First Responders to CBRN Terrorism Incidents”. In the 2007 edition, section 7.2.2.6 requires that “Class 3 garment materials shall be tested for evaporative heat transfer”. Class 3 also requires chemical permeation testing against warfare agents Mustard (HD), Soman (GD) as well as liquid toxic industrial chemicals Acrolein, Acrylonitrile, Dimethyl sulfate, and gaseous chemicals Amonia and Chlorine.

The need for comfort and chemical protection is well established but very few materials can offer both and those that do are very expensive. The traditional carbon based military suits protect by absorption of the large molecule warfare agents, but are easily permeated by the smaller molecule industrial toxic chemicals.

One W. L. Gore proprietary fabric that meets the requirement is Chempak, but the fabric is relatively expensive and thus considered a reusable. This raises the issue of decontamination, which is always a difficult issue to deal with if contaminated with hazardous substances.

There is an obvious need for a relatively inexpensive, limited use protective fabric that also offers a degree of comfort. The need exist not only for terrorism incidents but for general industrial and chemical protective work wear, especially in areas of the country where high temperature and high humidity work conditions exist.

### SUMMARY OF THE INVENTION

A principal object of this invention is to provide a fabric that will provide chemical protection and moisture vapor transmission that allows evaporative cooling to occur. This will provide more comfort with reduced heat stress, and potentially make longer work cycles possible.

It is a further object to provide a chemical protective breathable fabric at a cost point where the garment can be considered limited use, allowing for safe disposal after becoming contaminated with a hazardous material. This will eliminate the hazards associated with wearing a garment that has been decontaminated. Decontamination for reuse can be both risky and expensive.

Yet another objective is to provide a chemical resistant breathable fabric that be can readily converted into a protective garment. This requires that the seams be capable of being sealed to prevent intrusion of liquid contamination.

In one embodiment, the present invention is a breathable, semi-permeable, laminate that comprises a semi-permeable layer comprising regenerated cellulose film; and a textile layer bonded thereto.

In other embodiments, the present invention is a breathable, semi-permeable, laminate that comprises a semi-permeable layer having top and bottom surfaces; and at least one liquid impermeable layer bonded to at least one surface of the semi-permeable layer. Variations of this embodiment further include a textile layer.

Yet further embodiments of the present invention include articles. These articles comprise at least one multi-layered laminate, the laminate comprising at least one semi-permeable layer and at least one liquid impermeable layer; the semi-permeable being chosen from regenerated cellulose film or polyvinyl alcohol film.

In variations of this embodiment, each multi-layered laminate independently comprising a microporous film, monolithic film, or a combination or blend thereof. Further, variations of this embodiment further comprising at least one textile layer.

Aspects of the present invention include the articles described herein being fabricated into a garment. Examples include protective suits, tents, awning, protective shelters, equipment or supply covers, tarps, protective article containers, etc.

Other objects will be apparent to one of ordinary skill in the art when reviewing the instant specification and claims.

### BRIEF DESCRIPTION OF THE DRAWING

In order that the invention be more readily understood, some embodiments thereof are described in the figures, summarized here, by way of example only.

FIGS. 1-7 represent cross sections of embodiments of the present invention.

FIGS. 8-10 shows examples of seams of the present invention that may be used when using the laminates of the present invention to make various articles or composites.

### DESCRIPTION OF PREFERRED EMBODIMENTS

As stated above, an object of the present invention is to provide a fabric that provides chemical protection and moisture vapor transmission, thus allowing evaporative cooling to occur.

As used herein, these terms are defined as follows:

“Laminate” is a flexible article comprised of multiple flexible layers, resulting in a composite. Examples of laminates of the present invention can be comprised of a selective permeability layer and at least one liquid impermeable layer.

“Layer” refers to a discrete region of material, which, unless otherwise noted (e.g., by specifying that the layer is free-standing), may be in the form of a continuous film, coating, deposit, or any other desired form.

“Seam” is defined as the area where two or more pieces or panels of laminate are joined together by sewing, gluing, heat sealing, other mechanical joining procedures, and combinations thereof.

“Breathable” is defined as having the ability to transport moisture vapor (such as perspiration, for example) through a material. Breathable typically refers to materials having a Moisture Vapor Transmission Rate as measured by ASTM E96 and expressed in terms of g/m²/24 hr. When measuring breathability with The “breathability” of a material is measured in terms of moisture vapor transmission rate (MVTR), with higher values representing a more breathable material and lower values representing a less breathable material. The MVTR generally refers to the rate at which water vapor permeates through a material as measured in units of grams per meter squared per 24 hours (g/m²/24 hr). Quantatively, breathability is defined herein as any membrane with a water vapor flux greater than 100 g/m²/24 hr. Embodiments of the present invention have MVTR rates of over 100, over 200, over 300, over 500, over 1000, over 2000, over 3000, over 4000, etc., to over 5000.

“Nonwoven web” or “nonwoven” refers to a web having a structure of individual threads (e.g., fibers or filaments) that are randomly interlaid, not in an identifiable manner as in a knitted fabric. Nonwoven webs include, for example, meltblown webs, spunbond webs, carded webs, wet-laid webs, airlaid webs, coform webs, hydraulically entangled webs, etc.

“Semi-permeable” or “semi-permeability”, as used herein, means that the layer would significantly inhibit the flow of liquid or vapor from harmful chemicals from one side of the layer to the other. This phrase does not mean that the layer is necessarily impermeable to all vapors; for example, it may be permeable to water vapor. Preferably, impermeability is sufficient to comply with the chemical permeation resistance test required by NFPA 1994, as tested according to ASTM F739.

I. Semi-Permeability Layer

Embodiments of the present invention comprise a Selective Permeability Layer.

Selective permeability or semi-permeability refers to a membrane or film that blocks the movement of some molecules while allowing other molecules to diffuse through the film or membrane. For the current invention, films that allow moisture vapor molecules to defuse through the film while blocking liquid chemicals and potentially toxic vapors are considered.

Two such commercially available films are regenerated cellulose, commonly known as cellophane, and polyvinyl alcohol (PVOH). Both films are breathable as defined by moisture vapor transfer but block the movement of most liquid chemicals and toxic vapors. Of the two preceding examples, cellophane is preferred for this invention. PVOH can be dissolved by water. While cellophane may be degraded by prolonged exposure to water (dimensional change, weight change, etc.) it does not dissolve and tends to dry back to its original form.

The thickness of this layer can vary, and includes thicknesses ranging from about 0.5 to about 2.5 mils.

II. Liquid Impermeable Layer

This layer is a breathable, substantially liquid impermeable layer. In order to minimize any degradation in performance by the prolonged exposure to liquid water, the semi-permeable film in this invention may be protected by a vapor permeable (i.e., breathable), substantially liquid impermeable layer on one or both sides of the semi-permeable film. A microporous film that blocks the larger liquid molecules while allowing the smaller water vapor molecules to move through a series of microscopic voids in the film structure may be used. This allows the semi-permeable film to block the toxic liquids and vapors without being degraded by exposure to liquid water whether from the environment or from sweat on the wearer's skin.

Further examples include either a microporous structure or a monolithic film of hydrophilic polyester or hydrophilic polyurethane. Microporous is the preferred candidate if the finished product is to be considered limited use or disposable and monolithic being preferable if the finished product is to be reusable.

Additional examples include layers comprised of microporous polyolefins, stretched PTFE, and hydrophilic monolithic films such as hydrophilic monolithic polyesters and polyurethanes. Additionally, laminated combinations of the foregoing, wherein such combinations are permitted by the chemical and physical properties of the film, may be used.

One example of the Liquid Impermeability Layer of the present invention is the “microporous thermoplastic film” of U.S. Pat. No. 5,728,451, incorporated herein by reference. Thermoplastic polymers useful in this embodiment include olefinic, condensation and oxidation polymers. Representative olefinic polymers include high and low basis weight polyethylene, polypropylene, polyvinyl containing polymers, butadiene containing polymers and the like. Condensation polymers include polyesters such as polyethylene terephthalate and polybutylene terephthalate, polyamides such as nylon 6, nylon 13 and nylon 66, polycarbonates and polysulfones. Polyphenylene oxide is representative of the oxidation polymers which can be used. Blends of thermoplastic polymers may also be used in connection with this embodiment and others. While most of these thermoplastic polymers can be utilized in forming a suitable web for combining with microporous film, the microporous film should preferably be comprised of polymeric materials, i.e. thermoplastics, which can survive adhesive bonding, ultrasonic point bonding and the like without degenerating thus losing the barrier properties and yet maintaining moisture vapor permeability.

An additional embodiment is APTRA microporous polypropylene films available from RKW US, Inc., a subsidiary of RKW AG Rheinische Kunststoffwerke, including the film AP3. Embodiments of APTRA films have the following characteristics:

| Property | | Test method | Unit | Average value |
|---|---|---|---|---|
| Basis weight | | ASTM D751 | g/m² | 25 |
| Embossed caliper | | ASTM D751 | μm | 38 |
| Tensile strength | MD | ASTM D751 | N/inch | 18 |
| | CD | | | 16 |
| Tensile elongation | MD | ASTM D751 | % | 120 |
| | CD | | % | 75 |

| | | | |
|---|---|---|---|
| MVTR | ASTM E96, | g/m²/24 h | 5000 |
| | method E | | |

III. Textile Layer

A woven or nonwoven fabric may be laminated to one or both of the microporous surfaces to add strength and make the composite more textile like in nature.

The textile layer may be woven, knit, or nonwoven. A nonwoven textile layer is the preferable candidate if the product is to be considered limited use or disposable, woven being the preferred candidate of the product is to be considered reusable. As used herein, the term “nonwoven fabric or layer” means a web having a structure of individual fibers or threads which are interlaid, but not in an identifiable manner as in a knitted fabric. Nonwoven fabrics or webs have been formed from various processes such as, for example, meltblowing processes, spunbonding processes, and bonded carded web processes.

As one of ordinary skill in the art would appreciate, there are many on the market nonwoven products, such as polyester or polypropylene fabrics, or fabric blends that may be used in conjunction with this layer. That is, as indicated above, the textile layer may be any desired textile, including woven, knitted and nonwoven materials and composites of such materials. The textile may be selected based on the properties required for a given application, e.g., flame and/or heat resistance, thermal properties, comfort, weight, and moisture vapor transmissivity. Suitable textiles include 332N NOMEX fabric, available from Southern Mills, NYCO fabric, available in a camouflage print from Bradford Dye, and 70d taslanized nylon. Other suitable textiles include nonwovens such as VILENE nonwoven, commercially available from Freudenberg, and E89 nonwoven, commercially available from DuPont. The textile layer generally may have many variations in terms of thickness.

The textile layer generally does not contribute significantly chemical protection offered by the laminate, and does not significantly negatively affect the chemical or liquid protection offered by other layers of the laminate. The textile layer does frequently offer additional physical protection against abrasion tear and puncture.

IV. Adhesive Layer

In embodiments of the present invention, an adhesive layer may be used to bond the layers one to the other.

In certain embodiments of the present invention, the adhesive layer is a discontinuous adhesive layer, such as a spaced apart pattern applied using the gravure process or applied as random filaments of adhesive.

A variety of product concepts can be fully developed through adhesive bonding technology to meet the needs of various markets for non-wovens, composites and laminated structures. Among the products that can be produced by adhesive bonding are flat non-wovens that compete with fabrics made from spun-bonded, and thermal calender bonded technologies. Adhesive bonded fabrics are soft and drapable, similar to calender bonded products but can be made from a range of fiber types and at heavy weights with improved strength. Non-woven composites developed from adhesive technology meet market demands for both durable and disposable end uses.

One example of an adhesive of the present invention is the adhesive disclosed in U.S. Pat. No. 5,560,974, incorporated herein by reference. As discussed in US '974, modern substrate adhesive lamination is usually aimed at using the adhesive in three different forms: solvent borne solutions; aqueous dispersions; and 100% solid adhesive application techniques.

As described therein, the following adhesive systems can be used as embodiments of the present invention.

Finely divided, “powdered” hot-melt adhesive system: an adhesive system of this kind would typically be of 50-200 micron particle size distribution, possibly up to 300 microns. The adhesive system may be cryogenically ground in its route to manufacture--depending upon the glass transition temperature of the polymer.

Materials in this category can include polyethylene (LDPE or HDPE). Other polymers and copolymers include: ethylene vinyl acetate copolymer in which the proportion of vinyl acetate in the copolymer is about 18-33% by weight; copolyamides with a melt temperature of 85°-140° C.; and copolyesters with a melt temperature range of 85°-125° C. or higher. Other polymers less frequently used include polyvinyl chloride.

Additionally, pressure sensitive adhesives may be useful for joining unlike materials.

Typically, the most effective polymer cohesion is achieved between two substrates when the hot melt adhesive polymer type is compatible with the substrate. For example, a polyester substrate would be most effectively bonded by a condensation polymer system, i.e., copolymers of polyethylene terephthalate. A breathable polyethylene or polypropylene film with an additional polymer system e.g. polyethylene.

The powdered adhesive may be applied using a range of well recognized powder coating equipment/techniques to achieve various coating results. These would typically include Scatter coating; Powder-point coating; Paste-point coating; and Hot Melt print coating. These techniques result in a corresponding range of coating results including: Pastepoint; sintered powderpoint; Calendered powderpoint; Double-point; Scattercoating; and Hot-melt print coating.

The equipment used to achieve this result is well recognized within the coating and laminating industry. These include: Paste-point printing in which fine powder (Particle size: 0-80 microns) is mixed in an aqueous dispersion and applied in discrete points using a rotary screen printing process (at typically 8-20 gsm) followed by a drying process. Powder-point coating (adhesive particle size<200 microns) using an engraved roll/hot press rolls followed by an oven system with convection drying and IR—drying to sinlet the product. Scatter coating, in which finely divided powder (Particle size—to suit application>50 microns)—is applied at typically 10-30 gsm using conventional Scatter units and an oven system; and finally, Hot-melt Print coating: in which granules are melted in an extruder and applied by silk screen printing process or gravure printing process. Here, the coating weight is typically 15-20 gsm, and the choice of stencil or engraved roll pattern can be selected to satisfy particular coating requirements.

These methods of coating are usually incorporated into a simple lamination process.

Adhesive nonwoven bonded fabrics: An alternative route to adhesive lamination involves the use of an adhesive “scrim” in the form of a Nonwoven bonded fabric. These are typically manufactured by the Spun-laid method using extruded thermoplastic polymers which melt at low temperatures. The adhesive scrims are placed between two fabrics that are to be laminated, and are activated by subjecting them to heat and pressure to make them stick together. Two Nonwoven or other materials can be quickly and permanently bonded in this way (E.g. Codor process).

(i) Thermoplastic: Thermoplastic adhesive scrims of typically 0.5-1.0 oz/sq. yd.—depending upon the density of the polymer—are used as the bonding medium. Copolyester and Copolyamide polymers, based on plasticiser-free formulations, are used in “Medium Melt” lamination applications with an MFI-characteristic which guarantees bonding between typically 105-130 C. (221-248 F.). Vinyl Acetate formulations are also available with Melting Ranges of typically 120-125 C.

Polymers including medium-low to high density polyethylene also offer excellent scrim bonding properties at typically 110-125 (230-257 F.) for LDPE and 130-140 C. (266-284 F.) for HDPE. Polypropylene products are available with melting ranges 165-170 F. (329-338 F.) for higher “Medium Melt” applications. Other polymers systems are occasionally used in this application.

(ii) Thermoset: Resistance to conditions of end-use application more extreme than those used in the lamination process can be achieved through the use of reactive hot melt systems including polyureathane bicomponent adhesives, or cross-linkable aqueous dispersions. These systems result in actual permanent chemical bonds cross-links formed between adhesive and substrate. Some difficulties may be experienced with these systems due to: inherent stability of the raw materials; low initial strength due to the time to undergo full chemical reactions; environmental concerns connected with the use of reactive species; and the recycling of material irreversibly bonded by thermoset systems.

Alternatively, the layers may be thermally fused or pressure laminated, without any intervening adhesive. The process parameters for this operation will vary depending on the materials used for the non-textile and highly impermeable layers, and would be selected to provide good adhesion without significant damage or deterioration of any of the layers.

Yet another significant variation of the present invention would be a breathable chemical resistant fabric that would also be readily biodegradable. Regenerated cellulose may be extruded as a sheet to form cellophane of as a fiber to form viscose rayon. In the most basic form, the combination of a regenerated cellulose film (cellophane) laminated to a viscose rayon woven or nonwoven fabric would offer chemical resistance to a significant number of chemicals while maintaining good breathability as measured by MVTR and provide biodegradability when laminated with a discontinuous adhesive.

Yet another advantage of a garment made from a composite containing regenerated viscose is a natural anti-static property resulting from the moisture vapor permeability of the regenerated cellulose. There are numerous chemicals that produce vapors which can be ignited by a low energy spark such as discharge of static electricity. In other special applications, such as protective garments used in clean rooms to protect sensitive electronic components during manufacture, static control is essential. Due to the availability of moisture from the environment, or the wearer's skin, the regenerated cellulose will typically have a surface resistivity of ≦10¹¹ ohms/square. Surface resistivity in the range of 10⁵-10¹¹ ohms/square is considered to be static dissipative.

Articles of the present invention maybe fabricated into a variety of configurations which take advantage of the unique properties of the present invention. Traditional liquid proof seaming techniques apparent to those of skill in the art may be used to assemble laminate panels into desired configurations. For example, it is contemplated that suitable articles include garments and protective suits of many varieties, tents and other protective shelters, equipment and supply covers, and other such protective articles.

FIG. 1 shows a cross section of an example of a laminate of the present invention. This example represents a basic exemplary laminate. Layer 14 is a semi-permeability layer comprised of regenerated cellulose, commonly referred to as cellophane. This layer is laminated to a supporting textile layer 12 using a discontinuous adhesive layer 11 that does not inhibit the transfer of moisture vapor. The textile layer may be either a woven, knit or nonwoven. The discontinuous adhesive may be a spaced apart pattern applied using the gravure process or applied as random filaments of adhesive. The method of adhesive application is not critical as long as it allows sufficient moisture vapor transfer to occur. The laminate of FIG. 1 is useful in blocking some groups of chemicals such as aromatic hydrocarbons while allowing comfort as measured by moisture vapor transfer rate (ASTM E96). However, to avoid degradation of performance, a suit constructed from this material should be worn in a relatively liquid water free environment with a work duty cycle that does not cause the wearer to build up excessive liquid sweat on the wearer's skin.

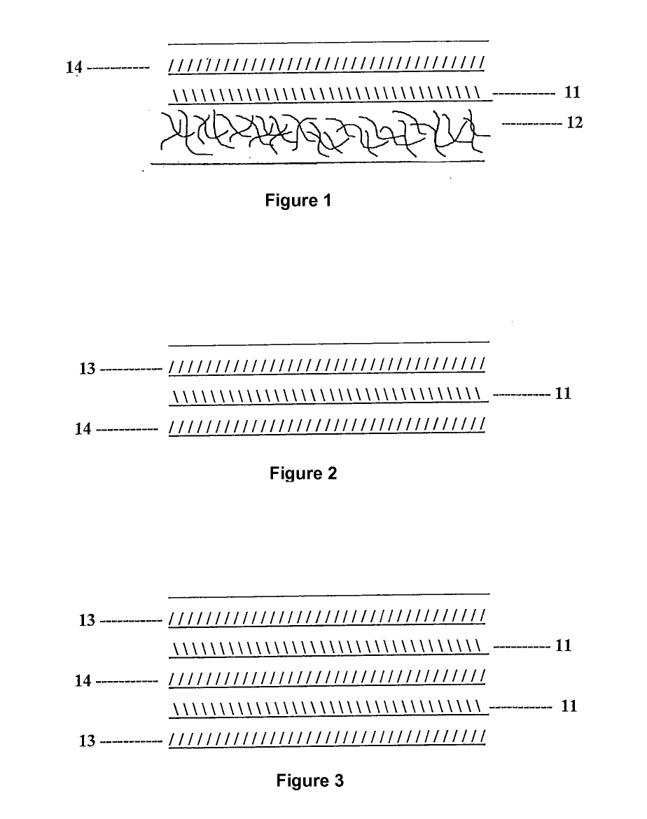

FIG. 2 shows a cross section of another film laminate example of the present invention. This example comprises a liquid impermeable layer (a vapor permeable, substantially liquid impermeable film layer) 13 laminated to a semi-permeable layer 14 by means of a discontinuous adhesive layer 11. One such vapor permeable, substantially liquid impermeable barrier is a microporous film where the larger liquid water molecules are blocked on the surface while the smaller water vapor molecules permeate through the micro pores. The film composite structure of FIG. 2 would minimize the degradation of the semi-permeable layer 14 from a liquid challenge to layer 13.

FIG. 3 shows a cross section of a film laminate with vapor permeable, substantially liquid impermeable film layers 13 laminated to both sides of semi-permeable layer 14 by means of discontinuous adhesive layer 11. Such an arrangement Hof layers protects the semi-permeable layer 14 from degradation caused by liquid water that may come from either the atmosphere or from the wearer's skin.

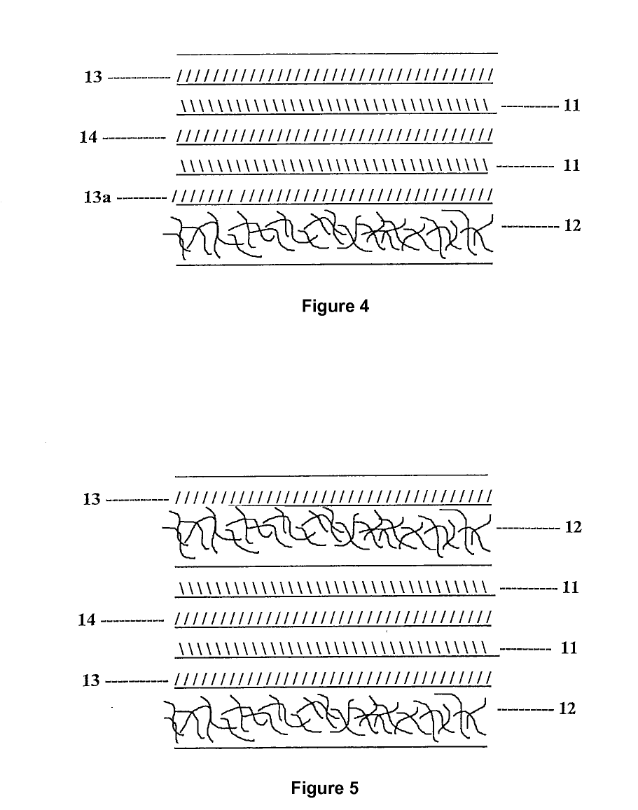

FIG. 4 shows a composite material consisting of vapor permeable, substantially liquid impermeable film layers 13 and 13a laminated to both surfaces of semi-permeable layer 14 by means of discontinuous adhesive layers 11. If textile layer 12 and layer 13 are compatible, it is preferable to ultrasonically weld layer 13 to layer 12 prior to adhesively laminating layer 13 to layer 14. As an alternative textile layer 12 may be adhesively laminated to layer 13 if ultrasonic welding is not possible. Textile layer 12 provides strength and a textile characteristic feel. The semi-permeable layer 14 is protected from liquids on either exterior surface. Layer 13a may be the same as layer 13 or as an alternative layer 13a may be the microporous surface of a commercially available incrementally stretched composite fabric (see Example 3).

FIG. 5 shows a composite material consisting of a vapor permeable, substantially liquid impermeable film layer 13 laminated to a nonwoven textile layer 12, preferably by ultrasonic welding. The exposed fabric side of layer 12 is further laminated to semi-permeable layer 14 by means of discontinuous adhesive layer 11. The exposed side of semi-permeable layer 14 is further laminated to a vapor permeable, substantially liquid impermeable film layer 13 by means of a discontinuous adhesive layer 11. Layer 13 is further laminated to textile layer 12, preferably by ultrasonic welding. Optionally the lamination of layers 13 to layers 12 may be accomplished by additional discontinuous adhesive layers 11 if layers 12 and 13 are not compatible to ultrasonic welding.

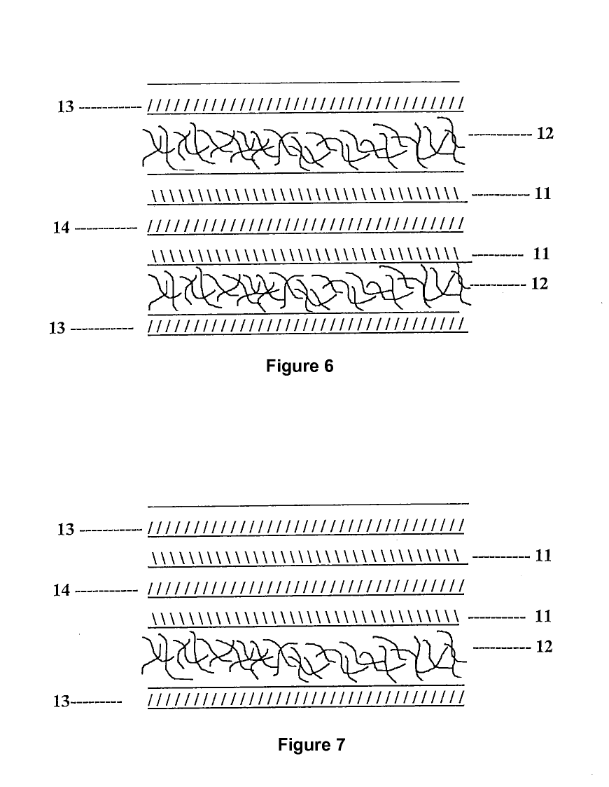

FIG. 6 shows a composite material consisting of a vapor permeable, substantially liquid impermeable film layer 13 laminated to a nonwoven textile layer 12, preferably by ultrasonic welding. The exposed fabric side of layer 12 is further laminated to semi-permeable layer 14 by means of discontinuous adhesive layer 11. The exposed side of semi-permeable layer 14 is further laminated to nonwoven textile layer 12 by means of discontinuous adhesive layer 11. Layer 13 is further laminated to textile layer 12, preferably by ultrasonic welding. Optionally the lamination of layers 13 to layers 12 may be accomplished by additional discontinuous adhesive layers 11 if layers 12 and 13 are not compatible to ultrasonic welding. In embodiments of this example, layers 12 and 13 may be first prepared by ultrasonic welding, and the nonwoven side 12 was adhesively laminated to both sides of semipermeable layer 14 by means of discontinuous adhesive layers 11.

FIG. 7 shows a composite material consisting of vapor permeable, substantially liquid impermeable film layer 13 laminated to a semi-permeable layer 14 by means of discontinuous adhesive layer 11. The exposed side of semipermeable layer 14 is further laminated to textile layer 12. An additional vapor permeable, substantially liquid impermeable film layer 13 is laminated to the exposed side of textile layer 12 by of ultrasonic welding, for example. If layers 12 and 13 are compatible, it is preferable to ultrasonically weld layer 13 to layer 12 prior to adhesively laminating layer 12 to layer 14. As an alternative textile layer 12 may be adhesively laminated to layer 13 if ultrasonic welding is not possible. Textile layer 12 provides strength and a textile characteristic feel. The semi-permeable layer 14 is protected from liquids on either exterior surface. Layer 13a may be the same as layer 13 or as an alternative layer 13a may be the microporous surface of a commercially available incrementally stretched composite fabric (see example 3).

As stated herein, the laminates of the present invention can be readily formed into many different articles. Nonlimiting examples include liners and covers, including tarps, tenting, tent liners, storage bags such as evidence bags, forensic containers, etc. Additional examples include protective apparel and other garments.

These articles can include pieces of laminates joined together. For the garments to be liquidproof and protective, there is a need to seal the seams where the panels of laminate are joined together.

One example is by first sewing the laminates together using conventional sewing techniques. Liquidproof sealing of these sewn seams can them be accomplished by the application of a seam tape. The seal seam may have a thermoplastic hot melt adhesive which seals to the surface of the laminate and creates a seal over the stitches.

An example of the seaming tape that can be used in connection with the present invention is the heat-bonded seaming tape described in U.S. Pat. No.5,167,697, incorporated herein by reference. The seaming tape described therein includes a first, base multilayer sheet that is usable by itself for certain less-demanding applications and a second multilayer sheet that, when laminated to and combined with the base sheet, provides an effective barrier to a wide spectrum of chemicals, giving a durable seam with the same barrier ability as is provided by the barrier fabric disclosed in my prior patent, referenced above. A sheet of polyethylene may also be disposed between the multilayered sheets to provide enhanced adhesion in forming the component sheets into a single tape.

The base multilayer sheet of this embodiment of the seam tape may comprise a stacked, laminated array of successive layers of polymeric film including an outside layer of ethylene vinyl acetate, which layer in use is disposed in contact with the fabric being seamed, a layer of polyvinylidene chloride, a second layer of ethylene vinyl acetate, and an outside layer of chlorinated polyethylene. The second multilayer sheet, may include an interior layer of ethylene vinyl alcohol sandwiched between layers of nylon or polyethylene.

Preparation of a seam between pieces of the barrier fabric may be carried out by placing the seaming tape over the fabric along the seam line with the ethylene vinyl acetate outside layer of the base tape in contact with the fabric and applying heat and pressure to obtain bonding with the fabric substrate. To obtain stronger and more durable seams, the fabric region may be stitched together, with the seaming tape covering the stitching to avoid leakage through needle holes. In addition, the seaming tape may be applied to both sides of the fabric as well as to one side only to provide a greater barrier effect.

Two further examples of seam tape include ZYTRON tapes from Kappler, Inc. and tapes from Seam Seam International, including T3NOK tape.

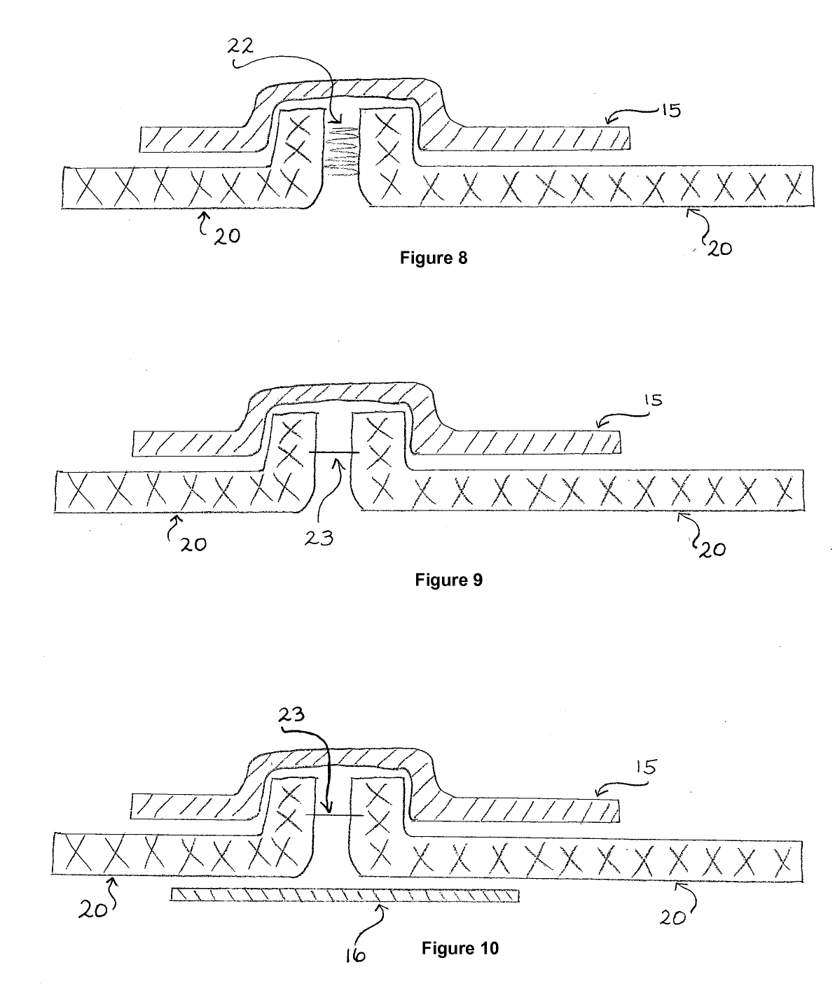

FIG. 8 shows a seam made by ultrasonically seaming the composite consisting of material described in FIG. 5 and then sealing that seam with chemical resistant tape to the film side (13).

FIG. 9 shows a seam made by sewing the composite consisting of material described in FIG. 5 and then sealing that seam with chemical resistant tape to the film side (13)

FIG. 10 shows a seam made by sewing the composite consisting of material described in FIG. 5 and then sealing that seam with chemical resistant tape to the film side (13) and additional seal tape the nonwoven side (12).

Test Methods

The chemical resistance of a barrier fabric is typically measured by ASTM F739. NFPA 1994 Class 3 specifies a battery of chemicals, challenge level, and test conditions. For preliminary testing Chloroethyl Ethyl Sulfide (CEES) was chosen as a surrogate for the warfare agent Mustard (HD) and Dimethyl Methyl-Phosphonate (DMMP) was chosen as a surrogate for the warfare agent Soman (GD). Breathability or comfort was measured by ASTM E96 Standard Test Methods for Water Vapor Transmission of Materials. It is common to measure physical strength using ASTM D751. When a test report indicates a chemical breakthrough time preceded by the greater than “>” symbol, the test was terminated at that time with no breakthrough being measured. Total Heat Loss was measured as specified by NFPA 1994 class 3.

### EXAMPLES

The following examples illustrate certain aspects of the present invention. Thus, they are to be interpreted as being exemplary of embodiments of the present invention and not to be interpreted as being limiting thereof.

### Example 1

A basic structure was prepared as described in FIG. 1. The moisture vapor permeable chemical resistant film layer 14 is comprised of a layer of regenerated cellulose commonly referred to as cellophane. The film is sold by Innovia Films under the designation NatureFlex 80P. Discontinuous adhesive layer 11 was applied using a gravure roller and pressure sensitive hot melt adhesive. Fabric layer 12 is a 2 oz/yd² spunbonded polypropylene. Test results for example 1 are summarized in Table 1.

### Example 2

A sample film composite was prepared as described in FIG. 3. The vapor permeable, liquid impermeable layers 13 consisted of microporous polypropylene films. The film is available from RKW Industries under the designation Aptra AP3. This film was adhesively laminated to semi-permeable layer 14 by means of discontinuous adhesive layers 11. Layer 14 consists of a cellophane film available from Innovia Films designated as Natureflex 80NP. Results for physical and chemical testing are shown in Table 2.

### Example 3

A sample fabric was prepared as generally described in FIG. 4. A vapor permeable, liquid impermeable layer 13 is a sheet of microporous Aptra AP3. The AP3 was laminated by means of a discontinuous adhesive layer 11 to a semi-permeable layer 14 that is comprised of 0.89 mil Natureflex 80NP cellophane. The microporous film side (layer 13a) of an incrementally stretched microporous coated spunbonded polypropylene nonwoven fabric composite (available from Clopay Plastic Products) was laminated to the opposite side of the semi-permeable layer 14 by means of discontinuous adhesive layer 11. The Aptra side of the final composite was exposed to the test chemicals. Results for physical and chemical testing are shown in Table 3.

### Example 4

A sample was prepared as indicated in FIG. 5. Layers 12 and 13 were first prepared by laminating RKW Aptra AP3 (layer 13) to 1 oz/yd² spunbonded polypropylene (layer 12) using ultra sonic welding. The semi-permeable layer 14 is a cellophane Natureflex 80NP. The exposed side of layer 12 was laminated to layer 14 by means of a discontinuous pressure sensitive hot melt adhesive layer 11 applied using a gravure roller. A second sheet consisting of layers 12 and 13 was prepared by ultrasonically welding AP3 (layer 13) to a 1 oz/yd² spunbonded polypropylene (layer 12). The exposed side of Natureflex 80NP (layer 14) was laminated to the exposed AP3 (layer 13) by means of a discontinuous pressure sensitive hot melt adhesive layer 11 applied using a gravure roller to complete the composite as indicated by FIG. 5.

Ultrasonic welding of layers 12 to 13 was utilized to minimize the amount of adhesive required in order to maintain maximum breathability. Results for physical testing are shown in Table 4.

### Example 5

A lab sample was prepared as indicated in FIG. 6. Layers 12 and 13 were first prepared by laminating RKW Aptra AP3 (layer 13) to 1 oz/yd² spunbonded polypropylene (layer 12) using ultra sonic welding. The semi-permeable layer 14 is a cellophane Natureflex 80NP. The exposed side of layer 12 was laminated to layer 14 by means of a discontinuous pressure sensitive adhesive layer 11 applied using a spray application. A second sheet consisting of layers 12 and 13 was prepared by ultrasonically welding AP3 (layer 13) to a 1 oz/yd² spunbonded polypropylene (layer 12). The exposed side of Natureflex 80NP (layer 14) was laminated to the spunbonded polypropylene (layer 12) by means of a discontinuous pressure sensitive adhesive layer 11 applied using a spray application to complete the composite as indicated by FIG. 5. Ultrasonic welding of layers 12 to 13 was utilized to minimize the amount of adhesive required in order to maintain maximum breathability.

### Example 6

A lab sample fabric was prepared as described in FIG. 7. A vapor permeable, liquid impermeable layer 13 is a sheet of microporous Aptra AP3. The AP3 was laminated by means of a discontinuous adhesive layer 11 to a semi-permeable layer 14 that is comprised of 0.89 mil Natureflex 80NP cellophane. Layers 12 and 13 were first prepared by laminating RKW Aptra AP3 (layer 13) to 1 oz/yd² spunbonded polypropylene (layer 12) using ultra sonic welding. The exposed side of Natureflex 80NP (layer 14) was laminated to the spunbonded polypropylene (layer 12) by means of a discontinuous pressure sensitive adhesive layer 11 applied using a spray application to complete the composite as indicated by FIG. 7. Ultrasonic welding of layers 12 to 13 was utilized to minimize the amount of adhesive required in order to maintain maximum breathability.

### Example 7

A fabric (20) produced by Example 4 was fused (22) together textile side (12) to textile side (12) using a ultrasonic sewing machine. As an optional embodiment, the seam was then overlaid with chemical resistant sealing tape (15) by means of a hot air sealing machine to a the film side. This feature is shown in FIG. 8. The multilayer chemical resistant sealing tape of this example is manufactured by Kappler Inc. and is designated as ZYTRON seam tape.

### Example 8

A fabric (20) produced by Example 4 was sewn textile side (12) to textile side (12) using a single needle lockstitch (23). As an optional embodiment, the seam was then overlaid with chemical resistant sealing tape (15) by means of a hot air sealing machine to a film side. This feature is shown in FIG. 9. An example of seam tape is the multilayer chemical resistant sealing tape is manufactured by Kappler Inc. and is designated as ZYTRON seam tape.

### Example 9

This Example shown an additional embodiment where the seam is sealed with a tape on both sides. As an example, a seam made by Example 8 was then further sealed on the textile side (12) using an additional seam sealing tape (16). This example uses a nylon reinforced seam sealing tape sold by Seam Seal Inc. under the designation T3NOK, while in other embodiments, the tape may be the same or different.

TABLE 1
Physical and Chemical Results for Example 1:

| Physical Test: | | | |
|---|---|---|---|
| Basis Weight | | 2.8 | oz/yd² |
| Grab Tensile | MD | 52.0 | lbs. |
| | XD | 35.9 | lbs. |
| Trap Tear | MD | 6.0 | lbs. |
| | XD | 8.5 | lbs. |

| | | |
|---|---|---|
| MVTR E96 (upright cup) | 826 | g/m²/24 hr |
| Surface Resistivity @ 72 F., 50% RH | 10¹⁰ | ohms/square |

TABLE 2
Physical and Chemical Results for Example 2:

| Physical Test: | | | |
|---|---|---|---|
| Basis Weight | | 2.6 | oz/yd² |
| Trap Tear | MD | 0.4 | lbs. |
| | XD | 1.3 | lbs. |

| | | |
|---|---|---|
| MVTR E96 | 703 | g/m²/24 hr |

TABLE 3
Physical and Chemical Results for Example 3:

| Physical Test: | | | |
|---|---|---|---|
| Basis Weight | | 3.9 | oz/yd² |
| Trap Tear | MD | 5.4 | lbs. |
| | XD | 7.1 | lbs. |

TABLE 4
Physical results for Example 4:

| Physical Test: | | | |
|---|---|---|---|
| Basis Weight | | 5.3 | oz/yd² |
| Grab Tensile | MD | 73.4 | lbs. |
| | XD | 76.8 | lbs. |
| Trap Tear | MD | 13.6 | lbs. |
| | XD | 23.4 | lbs. |

| | | |
|---|---|---|
| MVTR E96 (upright cup) | 516 | g/m²/24 hr |
| Total Heat Loss ASTM F 1868 | 212.4 | W/m² |
| NFPA 1994, class 3 | | |

TABLE 5
Chemical results permeation for Examples 2, 3 and 4:

| Example | | | |
|---|---|---|---|
| Number | Chemical Challenge | Result | Test Type |
| Example 2 | Dichloromethane | >480 | Normalized |
| Example 2 | Sulfuric Acid | 282 | Normalized |
| Example 2 | Acrolein | >120 | Normalized |
| Example 2 | Dimethyl Sulfate | >120 | Normalized |
| Example 2 | Ammonia | >480 | Normalized |
| Example 2 | Chlorine | >480 | Normalized |
| Example 3 | Chloroethyl Ethyl Sulfide | >120 | Normalized |
| Example 3 | Acrylonitrile | >120 | Normalized |
| Example 3 | Dimethyl Methylphosphonate | >120 | Normalized |
| Example 4 | Acrylonitrile | >60 | Normalized |
| Example 4 | Acrolein | >60 | Normalized |
| Example 4 | Dimethyl Sulfate | >60 | Normalized |
| Example 4 | Ammonia | >60 | Normalized |
| Example 4 | Chlorine | >60 | Normalized |

Test Method was ASTM F739 - 07 Standard Test Method for Permeation of Liquids and Gases through Protective Clothing Materials under Conditions of Continuous Contact. Test was preformed at NFPA 1994, 2007ed. Class 3 concentration levels.

TABLE 6
Chemical permeation results for Example 4:

| Example | | | |
|---|---|---|---|
| Number | Chemical challenge | Result | Test type |
| Example 4 | Dimethyl Sulfate | <1 ug/cm² for 1 hour | Cumulative |
| Example 4 | Acrylonitrile | <1 ug/cm² for 1 hour | Cumulative |
| Example 4 | Dimethyl Sulfate | <1 ug/cm² for 1 hour | Cumulative |

Test Method was NFPA 1994, Standard on Protective Ensembles for First Responders to CBRN Terrorism Incidents, 2007 Edition, Section 8.7.4 Class 3 Chemical Permeations.

TABLE 7
Chemical permeation results for Examples 7, 8, and 9:

| Example | | | |
|---|---|---|---|
| Number | Chemical challenge | Result | Test type |
| Example 5 | Dimethyl Sulfate | >60 | Normalized |
| Example 5 | Acrolein | >60 | Normalized |
| Example 6 | Dimethyl Sulfate | >60 | Normalized |
| Example 6 | Acrylonitrile | >60 | Normalized |
| Example 7 | Dimethyl Sulfate | >60 | Normalized |
| Example 7 | Acrylonitrile | >60 | Normalized |
| Example 7 | Aerolein | >60 | Normalized |

Test Method was ASTM F739 - 07 Standard Test Method for Permeation of Liquids and Gases through Protective Clothing Materials under Conditions of Continuous Contact. Test was preformed at NFPA 1994, 2007ed. Class 3 concentration levels.

As can be seen in the above tables the sample composites provide significant chemical resistance while maintaining an adequate MVTR for comfort. Table 4 demonstrates that it is relatively easy to control physical strengths through the selection of the fabrics laminated to one or both sides of the barrier films.

The seams of a protective garment made from any of the above examples are readily heat sealable since the outer surfaces are polyolefin based films or polyolefin nonwovens. The seams may be formed by ultrasonic seaming or may be overlaid with heat sealable tape.

The invention thus being described, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the Specification and Examples be considered as exemplary only, and not intended to limit the scope and spirit of the invention.

Unless otherwise indicated, all numbers expressing quantities, amounts, sizes, and properties such as reaction conditions, and so forth used in the Specification and exemplary claims are to be understood as being modified in all instances by the term “about.” Accordingly, unless indicated to the contrary, the numerical parameters set forth in the Specification and Claims are approximations that may vary depending upon the desired properties sought to be determined by the present invention.

Notwithstanding that the numerical ranges and parameters setting forth the broad scope of the invention are approximations, the numerical values set forth in the experimental or example sections are reported as precisely as possible. Any numerical value, however, inherently contain certain errors necessarily resulting from the standard deviation found in their respective testing measurements.

This specification references several patents, published patent applications, and other publications. All such publications are incorporated herein by reference in their entirety.

We claim:

1. A breathable, semi-permeable, laminate comprising:
a semi-permeable layer comprising regenerated cellulose film; and bonded thereto a textile layer.

2. The laminate of claim 1 where the textile layer is a woven, nonwoven, or knitted natural or synthetic fiber.

3. The laminate of claim 2 where the fiber is viscose rayon.

4. A breathable, chemical protective article made from the laminate of claim 1.

5. An article of claim 4, in the form of a breathable, chemical protective garment, responder suit, tent, awning, enclosed container.

6. The laminate of claim 1, further comprising at least one liquid impermeable layer.

7. The laminate of claim 1, wherein the textile layer is bonded to the semi-permeable layer by a non-continuous adhesive layer.

8. The laminate of claim 6, wherein a liquid impermeable layer is bonded to the semi-permeable layer.

9. A breathable, semi-permeable, laminate comprising:
a semi-permeable layer having top and bottom surfaces; and
at least one liquid impermeable layer bonded to at least one surface of the semi-permeable layer.

10. The laminate of claim 9, further comprising at least one textile layer.

11. The laminate of claim 10, wherein the semi-permeable layer is regenerated cellulose film.

12. The laminate of claim 10, wherein the semi-permeable layer is a polyvinyl alcohol film.

13. The laminate of claim 10, wherein the liquid impermeable layer is a microporous film, a monolithic film, or a blend or combination thereof.

14. The laminate of claim 10, wherein the microporous liquid impermeable layer is a microporous polyolefin film.

15. The laminate of claim 10, wherein the liquid impermeable layer is a monolithic film.

16. The laminate of claim 10, wherein a liquid impermeable layer is bonded to the top surface of the semi-permeable layer and a microporous liquid impermeable layer is bonded to the bottom surface of the semi-permeable layer.

17. The laminate of claim 10, wherein a liquid impermeable layer is bonded to a textile layer and a surface of the semi-permeable layer, and a second liquid impermeable layer is bonded to at least the other surface of the semi-permeable layer.

18. The laminate of claim 17, comprising, in order, a textile layer, a first liquid impermeable layer, a semi-permeable layer, and a second liquid impermeable layer.

19. The laminate of claim 18, wherein the textile layer and first liquid impermeable layer are bonded by ultrasonic bonding.

20. The laminate of claim 10, wherein the semi-permeable layer is bonded to the liquid impermeable layer by a discontinuous adhesive.

21. The laminate of claim 10, wherein the top and bottom surfaces of the semi-permeable layer are separated from the outer surfaces of the laminate by a liquid impermeable layer.

22. The laminate of claim 21, wherein the top and bottom surfaces of the semi-permeable layer are bonded to a liquid impermeable layer.

23. The laminate of claim 14, wherein the polyolefin is chosen from polypropylene, polyethylene, or blends thereof

24. The laminate of claim 10, wherein the textile is woven, knit, or nonwoven.

25. The laminate of claim 10, wherein the textile layer comprises polypropylene.

26. The laminate of claim 10, wherein the textile layer is a spunlaced fabric of cellulose and polyester.

27. The laminate of claim 9, having a MVTR of at least 100 g/m²/24 hr.

28. The laminate of claim 10, with a trap tear of at least 4 lbs.

29. An article, comprising:
at least one multi-layered laminate, the laminate comprising at least one semi-permeable layer and at least one liquid impermeable layer; the semi-permeable being chosen from regenerated cellulose film or polyvinyl alcohol film.

30. The article of claim 29, with each multi-layered laminate independently comprising a microporous film, monolithic film, or a combination or blend thereof.

31. The article of claim 29, the at least one laminate being fabricated into a protective garment.

32. The article of claim 29, further comprising at least one textile layer.

33. The article of claim 32, the article being fabricated into a garment.

34. The article of claim 33, the garment being a protective suit.

35. The article of claim 32, the article being fabricated into a tent, awning, protective shelter, equipment or supply cover, tarp, protective article container.

36. The article of claim 32, wherein each laminate comprises a liquid impermeable layer that is bonded to a textile layer and a surface of the semi-permeable layer, and a second liquid impermeable layer is bonded to at least the other surface of the semi-permeable layer.

37. The article of claim 36, wherein each laminate comprises, in order, a textile layer, a first liquid impermeable layer, a semi-permeable layer, and a second liquid impermeable layer.

38. The article of claim 32, wherein the top and bottom surfaces of the semi-permeable layer in each laminate are separated from the outer surfaces of the laminate by a liquid impermeable layer.

39. The article of claim 38, wherein at least one surface of the semi-permeable layer is bonded to a textile layer.

40. The article of claim 38, wherein at least one surface of the semi-permeable layer is bonded to a liquid impermeable layer.
